(19) United States
(12) Patent Application Publication
(10) Pub. No.: US 2019/0304383 A1
(43) Pub. Date: Oct. 3, 2019

(54) LIQUID CRYSTAL DISPLAY

(71) Applicant: SHENZHEN CHINA STAR OPTOELECTRONICS SEMICONDUCTOR DISPLAY TECHNOLOGY CO., LTD., Shenzhen (CN)

(72) Inventor: Sikun HAO, Shenzhen (CN)

(21) Appl. No.: 16/112,293

(22) Filed: Aug. 24, 2018

Related U.S. Application Data
(63) Continuation of application No. PCT/CN2018/092353, filed on Jun. 22, 2018.

(30) Foreign Application Priority Data
Apr. 2, 2018 (CN) 201810284742.X

(51) Int. Cl. G09G 3/36

(52) U.S. Cl. CPC G09G 3/3607; G02F 1/1368; G09G 3/3659

(57) ABSTRACT

Provided is a liquid crystal display, comprising a plurality of data lines and a plurality of scan lines, wherein the data lines and the scan lines intersect to form a plurality of pixel regions; each pixel region is provided with a switching TFT and a sub pixel, and a gate and a drain of the switching TFT are respectively connected to the scan line and the data line, and a source of the switching TFT is connected to the sub pixel; all switching TFTs in each row of pixel regions comprise first switching TFTs and second switching TFTs, and the first switching TFTs in each row of pixel regions are connected to a first scan line, a boundary of the row of pixel regions, and the second switching TFTs in each row of pixel regions are connected to a second scan line, a boundary of the row.

### CROSS-REFERENCE TO RELATED APPLICATION

This application is a continuing application of POT Patent Application No. POT/CN2018/092353 entitled “Liquid crystal display”, filed on Jun. 22, 2018, which claims priority to Chinese Patent Application No. 201810284742.X, filed on Apr. 2, 2018, both of which are hereby incorporated in its entireties by reference.

### FIELD OF THE INVENTION

The present invention relates to a display technology field, and more particularly to a liquid crystal display.

### BACKGROUND OF THE INVENTION

Liquid crystal display is one of the most widely used flat panel displays, and has gradually become widely used in various electronic devices, such as mobile phones, personal digital assistants (PDAs), digital cameras, computer screens or laptop screens, which has a display with a high resolution color screen. The current liquid crystal displays usually have an upper substrate, a lower substrate and an intermediate liquid crystal layer, and the substrate is composed of glass and electrodes. In case that both the upper substrate and lower substrate have electrodes, a vertical electric field mode display, such as a TN (Twist Nematic) mode, a VA (Vertical Alignment) mode can be developed and an MVA (Multi-domain Vertical Alignment mode) to solve the narrow viewing angle can be developed. In another type, unlike the above display, the electrodes are located only on one side of the substrate to form a display of a transverse electric field mode, such as an IPS (In-plane switching) mode and an FFS (Fringe Field Switching) mode.

FIG. 1 and FIG. 2 show two driving architectures commonly used in liquid crystal displays. FIG. 1 shows a diagram of a conventional driving architecture in a liquid crystal display. FIG. 2 shows a diagram of a tri-gate (Tri-Gate means that each pixel unit comprises three gate lines for driving, and each pixel unit comprises three rows of sub pixels) driving architecture in a liquid crystal display. FIG. 3 and FIG. 4 are circuit diagrams of conventional driving architecture and tri-gate driving architecture used in liquid crystal displays. In the tri-gate driving architecture, the number of data lines is reduced to ⅓ of the number of data lines in a conventional driving architecture, and the number of scan lines (also called gate lines) is increased to three times of the number of scan lines in a conventional driving architecture. Therefore, the COF (Chip on Film) carrying the data lines in the tri-gate driving architecture is reduced to ⅓ of the conventional driving architecture, and the width and charging time of each scan signal pulse are also reduced to ⅓ of the conventional driving architecture.

At present, the liquid crystal display panel gradually adopts the GOA (Gate Driver on Array) technology, which utilizes the original process of the flat display panel to fabricate the driving circuit of the horizontal scan line of the panel on the substrate around the display area. However, GOA technology is limited by the process and the external drive, and the driving abilities of the scan lines of different stages are different. This difference causes the horizontal stripes of the liquid crystal display shown in FIG. 5. Such disadvantage is particularly pronounced in large-size, high-resolution, tri-gate driven displays.

### SUMMARY OF THE INVENTION

For solving the aforesaid issues, the present invention provides a liquid crystal display capable of eliminating horizontal stripes of the liquid crystal display to improve the display quality.

The present invention provides a liquid crystal display, comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;

each pixel region is provided with a switching thin film transistor and a sub pixel, and a gate and a drain of the switching thin film transistor are respectively connected to the scan line and the data line, and a source of the switching thin film transistor is connected to the sub pixel;

all of the switching thin film transistors in each row of pixel regions comprise a plurality of first switching thin film transistors and a plurality of second switching thin film transistors, and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other.

Preferably, the sub pixels in each row of pixel regions or in each column of pixel regions are sub pixels of the same color, and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines.

Preferably, the red sub pixels, green sub pixels and blue sub pixels are arranged in adjacent three rows of pixel regions or adjacent three columns of pixel regions.

Preferably, as the sub pixels in each row of pixel regions are sub pixels of the same color, one of the first switching thin film transistors and one of the second switching thin film transistors are arranged in any two adjacent switching thin film transistors in the same row of pixel regions.

Preferably, as the sub pixels in each row of pixel regions are sub pixels of the same color, the red sub pixels, green sub pixels and blue sub pixels are arranged in any of the adjacent three rows of pixel regions.

Preferably, as the sub pixels in each column of pixel regions are sub pixels of the same color, each row of pixel regions comprises a plurality of sets of first switching thin film transistors and a plurality of sets of second switching thin film transistors;

the set of first switching thin film transistors comprises three adjacent first switching thin film transistors, and the set of second switching thin film ansistors comprises three adjacent three second switching thin film transistors;

the plurality of sets of first switching thin film transistors and the plurality of sets of second switching thin film transistors are spaced apart from each other.

Preferably, as the sub pixels in each column of pixel regions are sub pixels of the same color, the red sub pixels, green sub pixels and blue sub pixels are arranged in any of the adjacent three columns of pixel regions.

Preferably, the sub pixel comprises a liquid crystal capacitor.

Preferably, the plurality of data lines are used to access data signals of the same waveform, or some of the plurality of data lines are used to access data signals of the same waveform, and other data lines are used to access data signals of opposite waveforms.

The present invention further provides a liquid crystal display, comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;

each pixel region is provided with a switching thin film transistor and a sub pixel, and a gate and a drain of the switching thin film transistor are respectively connected to the scan line and the data line, and a source of the switching thin film transistor is connected to the sub pixel; the sub pixel comprises a liquid crystal capacitor;

all of the switching thin film transistors in each row of pixel regions comprise a plurality of first switching thin film transistors and a plurality of second switching thin film transistors, and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other;

wherein the sub pixels in each row of pixel regions or in each column of pixel regions are sub pixels of the same color, and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines.

Preferably, the red sub pixels, green sub pixels and blue sub pixels are arranged in adjacent three rows of pixel regions or adjacent three columns of pixel regions.

Preferably, as the sub pixels in each row of pixel regions are sub pixels of the same color; one of the first switching thin film transistors and one of the second switching thin film transistors are arranged in any two adjacent switching thin film transistors in the same row of pixel regions.

Preferably, as the sub pixels in each row of pixel regions are sub pixels of the same color, the red sub pixels, green sub pixels and blue sub pixels are arranged in any of the adjacent three rows of pixel regions.

Preferably, as the sub pixels in each column of pixel regions are sub pixels of the same color, each row of pixel regions comprises a plurality of sets of first switching thin film transistors and a plurality of sets of second switching thin film transistors;

the set of first switching thin film transistors comprises three adjacent first switching thin film transistors, and the set of second switching thin film transistors comprises three adjacent three second switching thin film transistors;

the plurality of sets of first switching thin film transistors and the plurality of sets of second switching thin film transistors are spaced apart from each other.

Preferably, as the sub pixels in each column of pixel regions are sub pixels of the same color, the red sub pixels, green sub pixels and blue sub pixels are arranged in any of the adjacent three columns of pixel regions.

Preferably, the plurality of data lines are used to access data signals of the same waveform; or some of the plurality of data lines are used to access data signals of the same waveform, and other data lines are used to access data signals of opposite waveforms.

The present invention further provides a liquid crystal display, comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;

each pixel region is provided with a switching thin film transistor and a sub pixel, and a gate and a drain of the switching thin film transistor are respectively connected to the scan line and the data line, and a source of the switching thin film transistor is connected to the sub pixel;

all of the switching thin film transistors in each row of pixel regions comprise a plurality of first switching thin film transistors and a plurality of second switching thin film transistors; and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other;

wherein the sub pixels in each row of pixel regions or in each column of pixel regions are sub pixels of the same color, and the sub pixels in each row of pixel regions or in each column of pixel regions are one of red sub pixels; green sub pixels and blue sub pixels; wherein each row of pixel regions is a pixel region between two adjacent scan lines, and each column of pixel regions is a pixel region between two adjacent data lines;

wherein the red sub pixels, green sub pixels and blue sub pixels are arranged in adjacent three rows of pixel regions or in adjacent three columns of pixel regions;

wherein as the sub pixels in each row of pixel regions are sub pixels of the same color, one of the first switching thin film transistors and one of the second switching thin film transistors are arranged in any two adjacent switching thin film transistors in the same row of pixel regions.

Preferably, as the sub pixels in each row of pixel regions are sub pixels of the same color, the red sub pixels, green sub pixels and blue sub pixels are arranged in any of the adjacent three rows of pixel regions.

Preferably, as the sub pixels in each column of pixel regions are sub pixels of the same color, each row of pixel regions comprises a plurality of sets of first switching thin film transistors and a plurality of sets of second switching thin film transistors;

the set of first switching thin film transistors comprises three adjacent first switching thin film transistors, and the set of second switching thin film transistors comprises three adjacent three second switching thin film transistors;

the plurality of sets of first switching thin film transistors and the plurality of sets of second switching thin film transistors are spaced apart from each other;

wherein as the sub pixels in each column of pixel regions are sub pixels of the same color, the red sub pixels, green sub pixels and blue sub pixels are arranged in any of the adjacent three columns of pixel regions.

Preferably, the sub pixel comprises a liquid crystal capacitor;

wherein the plurality of data lines are used to access data signals of the same waveform; or some of the plurality of data lines are used to access data signals of the same waveform, and other data lines are used to access data signals of opposite waveforms.

The implementation of the present invention possesses the following results: in the liquid crystal display provided by the present invention, the switching thin film transistors in each row of pixel regions are commonly driven by two scan lines at the boundary of the row of pixel regions. The plurality of first switching thin film transistors connected to the same scan line in the same row of pixel regions and the plurality of second switching thin film transistors connected to the other same scan line in the same row of pixel regions are spaced apart from each other. With such arrangement, the difference in driving ability between adjacent two scan lines can be eliminated or reduced, thereby eliminating horizontal stripes of the liquid crystal display and improving display quality.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a conventional driving architecture used in a liquid crystal displays according to the prior art.

FIG. 2 is a tri-gate driving architecture used in a liquid crystal displays according to the prior art.

FIG. 3 is a circuit diagram of a conventional driving architecture used in a liquid crystal displays according to the prior art.

FIG. 4 is a circuit diagram of a tri-gate driving architecture used in a liquid crystal displays according to the prior art.

FIG. 5 is a diagram showing horizontal stripes appearing on a liquid crystal display provided by the present invention.

FIG. 6 is a circuit diagram of the first embodiment of a driving architecture of a liquid crystal display provided by the present invention,

FIG. 7 is a circuit diagram of the second embodiment of a driving architecture of a liquid crystal display provided by the present invention.

FIG. 8 is a driving sequence diagram of a liquid crystal display provided by the present invention.

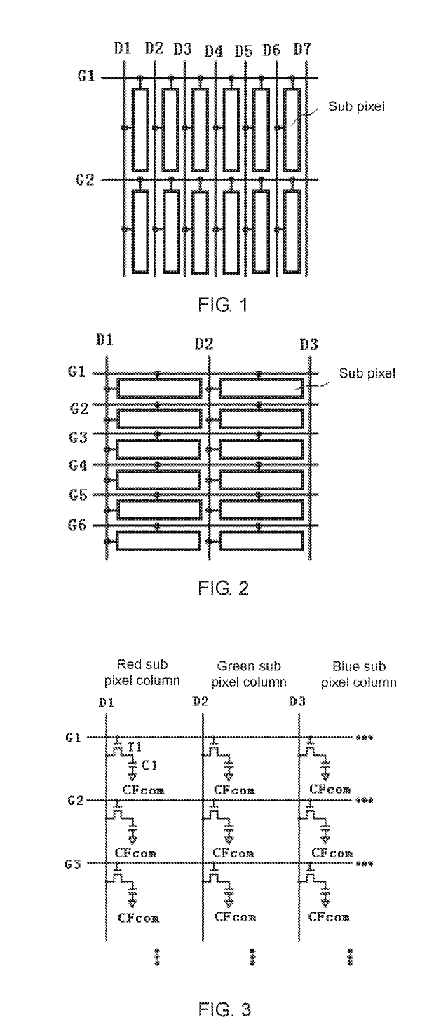

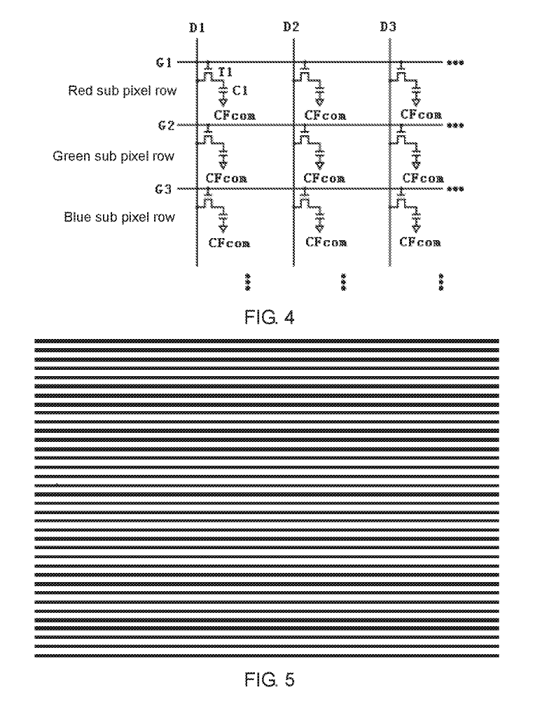

### DETAILED DESCRIPTION OF PREFERRED EMBODIMENTS

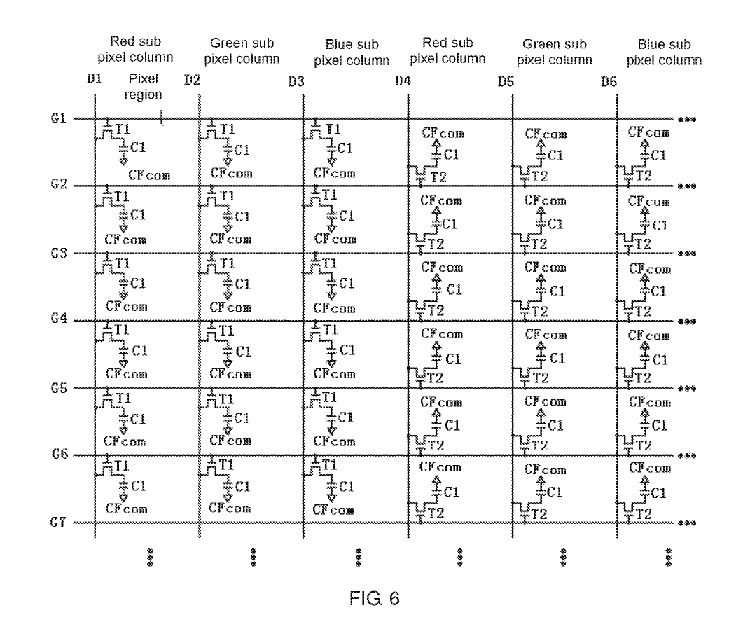

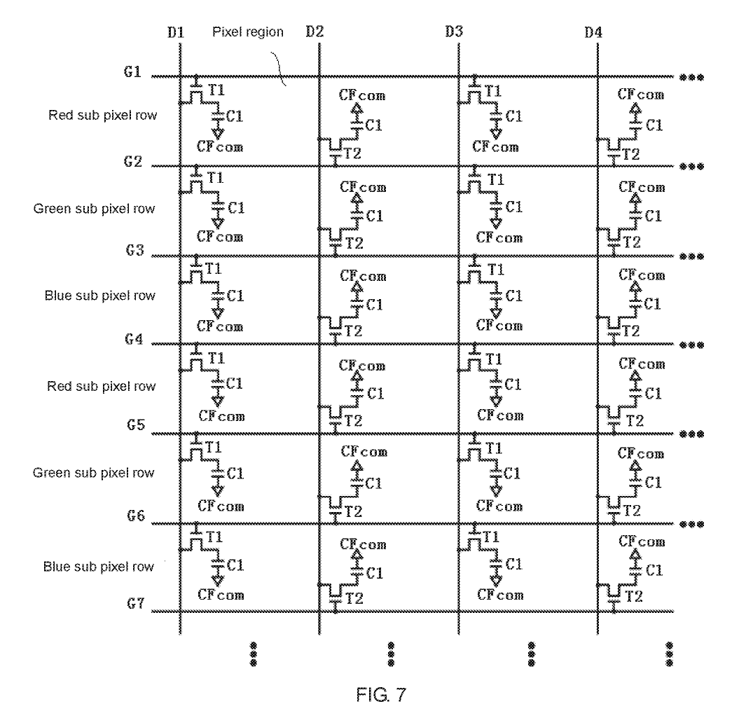

The present invention provides a liquid crystal display. The liquid crystal display comprises a plurality of data lines D1, D2, . . . , D6 and a plurality of scan lines G1, G2, . . . , G7 as shown in FIG. 6 or FIG. 7. The plurality of data lines and the plurality of scan lines intersect to form a plurality of pixel regions, and each pixel area is surrounded by two adjacent data lines and two adjacent scan lines. For instance, a region surrounded between two adjacent scan lines G1, G2 and two adjacent data lines D1, D2 is a pixel region.

Each pixel region is provided with a switching thin film transistor and a sub pixel, and a gate and a drain of the switching thin film transistor are respectively connected to the scan line and the data line, and a source of the switching thin film transistor is connected to the sub pixel. Here, the sub pixel comprises one liquid crystal capacitor C1, and the sub pixel may be one of a red sub pixel, a green sub pixel and a blue sub pixel. The liquid crystal capacitor C1 comprises a pixel electrode and a common electrode arranged opposite to each other. The pixel electrode is connected to the switching thin film transistor, and the common electrode is connected to the common electrode line CFcom of the color filter substrate.

All of the switching thin film transistors in each row of pixel regions comprise a plurality of first switching thin film transistors T1 and a plurality of second switching thin film transistors T2, and the first switching thin film transistors T1 in each row of pixel regions are connected to a first scan line that is a boundary of the row of pixel regions, and the second switching thin film transistors T2 in each row of pixel regions are connected to a second scan line that is a boundary of the row of pixel regions, and the plurality of first switching thin film transistors T1 and the plurality of second switching thin film transistors T2 are spaced apart from each other.

For instance, as shown in FIG. 6 and FIG. 7, the first switching thin film transistors T1 in the first row of pixel regions are connected to the scan line G1 which is the upper boundary of the row of pixel regions, that is, the scan line G1 is the first scan line which is the boundary of the first row of pixel regions. The second switching thin film transistors T2 in the first row of pixel regions are connected to the scan line G2 which is the lower boundary of the row of pixel regions, that is, the scan line G2 is the second scan line which is the boundary of the first row of pixel regions.

Preferably, the first switching thin film transistor T1 and the second switching thin film transistor T2 may both be P-type thin film transistors.

Furthermore, the sub pixels in each row of pixel regions or in each column of pixel regions are sub pixels of the same color, and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines.

Furthermore, the red sub pixels, green sub pixels and blue sub pixels are arranged in adjacent three rows of pixel regions or adjacent three columns of pixel regions.

Furthermore, as the sub pixels in each row of pixel regions are sub pixels of the same color, one of the first switching thin film transistors T1 and one of the second switching thin film transistors T2 are arranged in any two adjacent switching thin film transistors in the same row of pixel regions;

Furthermore, as the sub pixels in each row of pixel regions are sub pixels of the same color, the red sub pixels, green sub pixels and blue sub pixels are arranged in any of the adjacent three rows of pixel regions.

Furthermore, as the sub pixels in each column of pixel regions are sub pixels of the same color, each row of pixel regions comprises a plurality of sets of first switching thin film transistors and a plurality of sets of second switching thin film transistors.

The set of first switching thin film transistors comprises three adjacent first switching thin film transistors T1, and the set of second switching thin film transistors comprises three adjacent three second switching thin film transistors T2.

The plurality of sets of first switching thin film transistors and the plurality of sets of second switching thin film transistors are spaced apart from each other.

Furthermore, as the sub pixels in each column of pixel regions are sub pixels of the same color, the red sub pixels, green sub pixels and blue sub pixels are arranged in any of the adjacent three columns of pixel regions.

As shown in FIG. 6, in the first embodiment, the sub pixels in each column of pixel regions are sub pixels of the same color. The first three columns are a red sub pixel column, a green sub pixel column and a blue sub pixel column, and these adjacent three columns of sub pixels may constitute a column of pixel units, After the first column of pixel units, the red sub pixel column, the green sub pixel column and the blue sub pixel column are arranged side by side to form a second column of pixel units. Thus, the driving architecture shown in FIG. 6 can be regarded as a plurality of columns of side-by-side pixel units, and every three data lines drive one pixel unit.

Each column of pixel regions is a pixel region between two adjacent data lines. For instance, the first column of pixel regions is a pixel region between the data line D1 and data line D2, and the second column of pixel regions is a pixel region between the data line D2 and data line D3.

As shown in FIG. 6, each row of pixel regions comprises a plurality of first switching thin film transistors T1 and a plurality of second switching thin film transistors T2. The adjacent three first switching thin film transistors T1 constitute a set of first switching thin film transistors, and the adjacent three second switching thin film transistors T2 constitute a set of second switching thin film transistors, and the plurality of first switching thin film transistors and the plurality of second switching thin film transistors are spaced apart from each other.

In the second embodiment, as shown in FIG. 7, the sub pixels in each row of pixel regions are sub pixels of the same color. The first three rows are a red sub pixel rows, a green sub pixel row and a blue sub pixel row, and every adjacent three rows of sub pixels may constitute one row of pixel units. After the first row of pixel units, the red sub pixel row, the green sub pixel row and the blue sub pixel row are arranged side by side to form a second row of pixel units. Thus, the driving architecture shown in FIG. 7 can be regarded as a plurality of rows of side-by-side pixel units, and every three scan lines drive one pixel unit.

Each row of pixel regions is a pixel region between two adjacent scan lines. For instance, the first row of pixel regions is a pixel region between the scan line G1 and scan line G2, and the second row of pixel regions is a pixel region between the scan line G2 and scan line G3.

In each row of pixel regions shown in FIG. 7 and in the first column of pixel regions and the second column of pixel regions which are adjacent, the switching thin film transistors in the first column of pixel regions are the first switching thin film transistors T1, and the switching thin film transistors in the second column of pixel regions are the second switching thin film transistor T2. Similarly, the switching thin film transistors in the third column of pixel regions are the first switching thin film transistors T1, and the switching thin film transistors in the fourth column of pixel regions are the second switching thin film transistor T2.

In the two embodiments shown in FIG. 6 and FIG. 7, each row of pixel regions is driven by scan lines of two adjacent rows. The first switching thin film transistor T1 and the second switching thin film transistor T2 respectively driven by the two scan lines are evenly distributed. Even if the driving abilities of adjacent two scan lines are different, since the first switching thin film transistors T1 and the second switching thin film transistors T2 of each row of pixel regions are respectively driven by two adjacent scan lines, the difference in driving abilities of adjacent two scan lines can be reduced, such that the liquid crystal display does not exhibit horizontal stripes, particularly the liquid crystal display with high resolution at present, and the slight difference between individual pixel regions is difficult for the human eye to distinguish.

In the driving architecture shown in FIG. 6, each pixel unit comprises a red sub pixel, a green sub pixel, and a blue sub pixel. In each row of pixel regions, adjacent pixel units are driven by two different scan lines. In the case of pure gray scale display, the liquid crystal display does not exhibit horizontal stripes, and no color shift occurs between adjacent two rows of pixels.

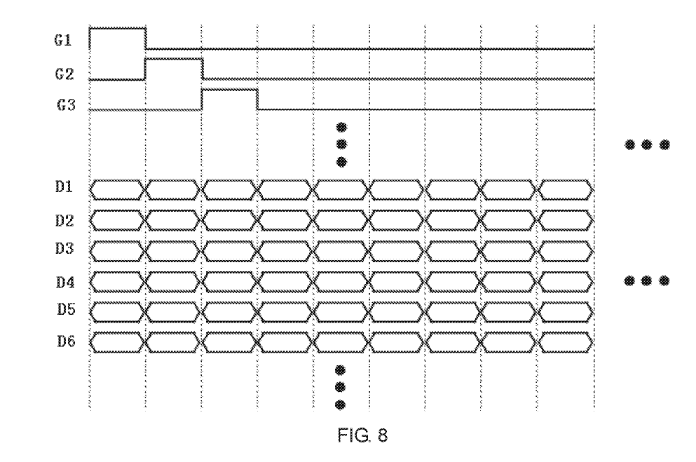

Furthermore, as shown in FIG. 8, the plurality of data lines are used to access data signals of the same waveform, or some of the plurality of data lines are used to access data signals of the same waveform, and other data lines are used to access data signals of opposite waveforms.

In conclusion, in the liquid crystal display provided by the present invention, the switching thin film transistors in each row of pixel regions are commonly driven by two scan lines at the boundary of the row of pixel regions. The plurality of first switching thin film transistors T1 connected to the same scan line in the same row of pixel regions and the plurality of second switching thin film transistors T2 connected to the other same scan line in the same row of pixel regions are spaced apart from each other. With such arrangement, the difference in driving ability between adjacent two scan lines can be eliminated or reduced, thereby eliminating horizontal stripes of the liquid crystal display and improving display quality.

The above content with the specific preferred embodiments of the present invention is further made to the detailed description, the specific embodiments of the present invention should not be considered limited to these descriptions. Those of ordinary skill in the art for the present invention, without departing from the spirit of the present invention, can make various simple deduction or replacement, should be deemed to belong to the scope of the present invention.

What is claimed is:

1. A liquid crystal display, comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;
each pixel region is provided with a switching thin film transistor and a sub pixel, and a gate and a drain of the switching thin film transistor are respectively connected to the scan line and the data line, and a source of the switching thin film transistor is connected to the sub pixel;
all of the switching thin film transistors in each row of pixel regions comprise a plurality of first switching thin film transistors and a plurality of second switching thin film transistors, and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other.

2. The liquid crystal display according to claim 1, wherein the sub pixels in each row of pixel regions or in each column of pixel regions are sub pixels of the same color, and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines.

3. The liquid crystal display according to claim 2, wherein the red sub pixels, green sub pixels and blue sub pixels are arranged in adjacent three rows of pixel regions or adjacent three columns of pixel regions.

4. The liquid crystal display according to claim 2, wherein as the sub pixels in each row of pixel regions are sub pixels of the same color, one of the first switching thin film transistors and one of the second switching thin film transistors are arranged in any two adjacent switching thin film transistors in the same row of pixel regions.

5. The liquid crystal display according to claim 4, wherein as the sub pixels in each row of pixel regions are sub pixels of the same color, the red sub pixels, green sub pixels and blue sub pixels are arranged in any of the adjacent three rows of pixel regions.

6. The liquid crystal display according to claim 2, wherein as the sub pixels in each column of pixel regions are sub pixels of the same color, each row of pixel regions comprises a plurality of sets of first switching thin film transistors and a plurality of sets of second switching thin film transistors;
the set of first switching thin film transistors comprises three adjacent first switching thin film transistors, and the set of second switching thin film transistors comprises three adjacent three second switching thin film transistors;
the plurality of sets of first switching thin film transistors and the plurality of sets of second switching thin film transistors are spaced apart from each other.

7. The liquid crystal display according to claim 6, wherein as the sub pixels in each column of pixel regions are sub pixels of the same color, the red sub pixels, green sub pixels and blue sub pixels are arranged in any of the adjacent three columns of pixel regions.

8. The liquid crystal display according to claim 1, wherein the sub pixel comprises a liquid crystal capacitor.

9. The liquid crystal display according to claim 1, wherein the plurality of data lines are used to access data signals of the same waveform, or some of the plurality of data lines are used to access data signals of the same waveform, and other data lines are used to access data signals of opposite waveforms.

10. A liquid crystal display, comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;
each pixel region is provided with a switching thin film transistor and a sub pixel, and a gate and a drain of the switching thin film transistor are respectively connected to the scan line and the data line, and a source of the switching thin film transistor is connected to the sub pixel; the sub pixel comprises a liquid crystal capacitor;
all of the switching thin film transistors in each row of pixel regions comprise a plurality of first switching thin film transistors and a plurality of second switching thin film transistors, and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other;
wherein the sub pixels in each row of pixel regions or in each column of pixel regions are sub pixels of the same color, and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines.

11. The liquid crystal display according to claim 10, wherein the red sub pixels, green sub pixels and blue sub pixels are arranged in adjacent three rows of pixel regions or in adjacent three columns of pixel regions.

12. The liquid crystal display according to claim 10, wherein as the sub pixels in each row of pixel regions are sub pixels of the same color, one of the first switching thin film transistors and one of the second switching thin film transistors are arranged in any two adjacent switching thin film transistors in the same row of pixel regions.

13. The liquid crystal display according to claim 12, wherein as the sub pixels in each row of pixel regions are sub pixels of the same color, the red sub pixels, green sub pixels and blue sub pixels are arranged in any of the adjacent three rows of pixel regions.

14. The liquid crystal display according to claim 10, wherein as the sub pixels in each column of pixel regions are sub pixels of the same color, each row of pixel regions comprises a plurality of sets of first switching thin film transistors and a plurality of sets of second switching thin film transistors;
the set of first switching thin film transistors comprises three adjacent first switching thin film transistors, and the set of second switching thin film transistors comprises three adjacent three second switching thin film transistors;
the plurality of sets of first switching thin film transistors and the plurality of sets of second switching thin film transistors are spaced apart from each other.

15. The liquid crystal display according to claim 14, wherein as the sub pixels in each column of pixel regions are sub pixels of the same color, the red sub pixels, green sub pixels and blue sub pixels are arranged in any of the adjacent three columns of pixel regions.

16. The liquid crystal display according to claim 10, wherein the plurality of data lines are used to access data signals of the same waveform, or some of the plurality of data lines are used to access data signals of the same waveform, and other data lines are used to access data signals of opposite waveforms.

17. A liquid crystal display; comprising a plurality of data lines and a plurality of scan lines, wherein the plurality of data lines and the plurality of scan lines intersect to form a plurality of pixel regions, and each pixel area is surrounded by two adjacent data lines and two adjacent scan lines;
each pixel region is provided with a switching thin film transistor and a sub pixel, and a gate and a drain of the switching thin film transistor are respectively connected to the scan line and the data line, and a source of the switching thin film transistor is connected to the sub pixel;
all of the switching thin film transistors in each row of pixel regions comprise a plurality of first switching thin film transistors and a plurality of second switching thin film transistors, and the first switching thin film transistors in each row of pixel regions are connected to a first scan line that is a boundary of the row of pixel regions, and the second switching thin film transistors in each row of pixel regions are connected to a second scan line that is a boundary of the row of pixel regions, and the plurality of first switching thin film transistors and the plurality of second switching thin film transistors are spaced apart from each other;
wherein the sub pixels in each row of pixel regions or in each column of pixel regions are sub pixels of the same color; and the sub pixels in each row of pixel regions or in each column of pixel regions are one of red sub pixels, green sub pixels and blue sub pixels; wherein each row of pixel regions is a pixel region between two adjacent scan lines, and each column of pixel regions is a pixel region between two adjacent data lines;
wherein the red sub pixels, green sub pixels and blue sub pixels are arranged in adjacent three rows of pixel regions or in adjacent three columns of pixel regions;
wherein as the sub pixels in each row of pixel regions are sub pixels of the same color, one of the first switching thin film transistors and one of the second switching thin film transistors are arranged in any two adjacent switching thin film transistors in the same row of pixel regions.

18. The liquid crystal display according to claim 17, wherein as the sub pixels in each row of pixel regions are sub pixels of the same color, the red sub pixels, green sub pixels and blue sub pixels are arranged in any of the adjacent three rows of pixel regions.

19. The liquid crystal display according to claim 17, wherein as the sub pixels in each column of pixel regions are sub pixels of the same color, each row of pixel regions comprises a plurality of sets of first switching thin film transistors and a plurality of sets of second switching thin film transistors;
the set of first switching thin film transistors comprises three adjacent first switching thin film transistors, and the set of second switching thin film transistors comprises three adjacent three second switching thin film transistors;
the plurality of sets of first switching thin film transistors and the plurality of sets of second switching thin film transistors are spaced apart from each other;
wherein as the sub pixels in each column of pixel regions are sub pixels of the same color; the red sub pixels, green sub pixels and blue sub pixels are arranged in any of the adjacent three columns of pixel regions.

20. The liquid crystal display according to claim 17, wherein the sub pixel comprises a liquid crystal capacitor;
wherein the plurality of data lines are used to access data signals of the same waveform, or some of the plurality of data lines are used to access data signals of the same waveform, and other data lines are used to access data signals of opposite waveforms.
